(19) United States
(12) Patent Application Publication
(10) Pub. No.: US 2012/0243536 A1
(43) Pub. Date: Sep. 27, 2012

(54) METHOD AND APPARATUS FOR TRANSMITTING AND RECEIVING MULTICAST DATA IN SOCIAL NETWORKS

(75) Inventor: Álvaro Fernández Gutiérrez, Barcelona (ES)

(73) Assignee: MEDIA PATENTS, S.L., Barcelona (ES)

(21) Appl. No.: 13/069,138

(22) Filed: Mar. 22, 2011

(51) Int. Cl. H04L 12/56

(52) U.S. Cl. 370/390

(57) ABSTRACT

A method of transmitting first content from a first host to a second host in a data network using a social network site in the data network, the first host identifiable by a first IP address. According to one implementation the method involves receiving in the social network site a first unicast message from the first host related to a transmission of the first content from the first host, the first unicast message including the first IP address and a multicast group address to be used in the transmission of the first content. Upon or after the social network site determining that a social relationship exists between the first host and the second host the social network site sends a second unicast message to the second host indicating that the first host has or will initiate a transmission of the first content. The second unicast message includes the first IP address and the multicast group address in a form useable by the second host to request and receive via the data network the first content in the form of multicast packets.

### TECHNICAL FIELD

The invention relates to multicast technology in data networks.

### BACKGROUND

Multicast technology makes it possible to send data from a single source to many recipients through a data network, without having to set up unicast communication, i.e. one-to-one individual communication between the source and each of the recipients. To that end the source sends data, in data packet form, to a single address associated to a multicast group to which the equipment interested in being recipients of the data sending can subscribe. This address, referred to as a multicast address or also as a multicast group address, is an IP (Internet Protocol) address chosen within a range that is reserved for multicast applications. The data packets which have been sent by the source to the multicast address are then replicated in the different network routers so that they can reach the recipients that have joined the multicast group.

The recipients which receive data in a multicast group are usually equipment connected to the data network by means of a proxy or a router. Hereinafter, the common term host will be used to refer to the recipient equipment. A host can be, for example, a computer or a set-top box (digital signal decoder) connected to a television set.

When a host wants to receive the information sent by one or several sources of a multicast group, it sends to the closest router, or to an intermediate proxy, a subscription message to subscribe to the group so that the router transmits to it the data arriving through the data network and which has been sent by the sources of the multicast group. Likewise, when a host wishes to stop receiving data sending in the multicast group, it sends to the router or to the proxy an unsubscribe message to stop receiving them.

The messages exchanged between a host and the closest router to manage membership to a multicast group use the IGMP protocol (Internet Group Management Protocol) or the MLD (Multicast Listener Discovery) protocol, according to whether or not the router works with version 4 (IPv4) or version 6 (IPv6) of the IP protocol (Internet Protocol), respectively.

When there is a proxy between the host and the router, the proxy also uses the IGMP/MLD protocols to exchange with the host, the closest router or other intermediate proxy, the multicast group membership messages. In these cases, the proxy can receive from different hosts requests to subscribe to or to unsubscribe from a multicast group, and it assembles them to thus reduce IGMP/MLD message traffic it sends to the router. Hereinafter, the generic term IGMP proxy will be used to designate a proxy using the IGMP/MLD protocols.

In addition, routers exchange messages with one another for the purpose of defining the routing which allows efficiently routing the data from the sources to the hosts that have subscribed to a multicast group. To that end, the routers use specific protocols, including the very well known PIM-SM (Protocol Independent Multicast-Sparse Mode).

In summary, the routers receive from the hosts, in the form of IGMP/MLD messages, information specifying which multicast groups they want to receive traffic from, and they communicate with other routers, for example by means of the PIM-SM protocol, for the purpose of setting up a routing which takes the traffic requested by the hosts to such hosts.

All the mentioned protocols are defined and documented by the Internet Engineering Task Force (IETF).

The IGMP protocol version currently being used is IGMPv3, which is described in the RFC 3376 specifications published on line by the IETF (B. Cain et al., Engineering Task Force, Network Working Group, Request for Comments 3376, October 2002; currently available at Internet address http://tools.ietf.org/html/rfc3376).

With regard to the MLD protocol, the version currently being used is MLDv2, which is described in the RFC 3810 specifications published on line by the IETF (R. Vida et al., Engineering Task Force, Network Working Group, Request for Comments 3810, June 2004; currently available at Internet address http://tools.ietf.org/html/rfc3810).

The operation of an IGMP proxy is described in the RFC 4605 specifications published on line by the IETF (B. Fenner et al., Engineering Task Force, Network Working Group, Request for Comments 4605, August 2006; currently available at Internet address http://tools.ietf.org/html/rfc4605).

The PIM-SM protocol used for the communication between routers is described in the RFC 4601 specifications published on line by the IETF (B. Fenner et al., Engineering Task Force, Network Working Group, Request for Comments 4601, August 2006; currently available at Internet address http://tools.ietf.org/html/rfc4601).

Multicast technology was initially implemented primarily to be applied to the many-to-many communication model, known as ASM (Any Source Multicast), in which many users communicate with one another and any of them can send data and also receive data from everyone else. A typical ASM application is multiparty calling via Internet.

Multicast technology was then implemented to be applied to the one-to-many communication model known as SSM (Source Specific Multicast), in which a single source sends data for many recipients. Radio and television via Internet are SSM applications. This is why SSM is currently very interesting.

In earlier IGMP protocol versions, a host could not choose the data sending sources it did not want to subscribe to within a multicast group, rather the host could only subscribe to or unsubscribe from the group for all the sources. The messages a host sent to a router were very simple: Join (G) to receive traffic from the multicast group G and Leave (G) to stop receiving it. Therefore, earlier IGMP protocol versions did not allow SSM.

The possibility that the hosts could choose the sources within a multicast group was introduced in the IGMPv3 version of the IGMP protocol to allow SSM. To that end, a host can send IGMP messages containing data blocks referred to as Group Record in which the host defines the sources from which traffic is to be received for each multicast group. These Group Record data blocks in an IGMP message can be of several types:
An INCLUDE type Group Record data block containing information on source IP addresses from which the host wishes to receive data sending. According to the terminology of the RFC 3376 specifications, the sources chosen by means of an IGMP message containing an INCLUDE type Group Record are referred to as INCLUDE sources.
An EXCLUDE type Group Record data block, containing information on source IP addresses from which the host does not wish to receive data sending. In this case, it is interpreted that the host wishes to receive data sent by all the sources of the multicast group except the sources indicated as excluded in the message. According to the terminology of the RFC 3376 specifications, the excluded sources by means of an IGMP message containing an EXCLUDE type Group Record are referred to as EXCLUDE sources.

In IGMPv3 each network interface can operate for each multicast group only in one of the following two modes, being able to switch from one to the other: an INCLUDE mode in which the network interface defines an INCLUDE source list or an EXCLUDE mode in which the network interface defines an EXCLUDE source list.

Each network interface and multicast group has a state record storing the information on the interface and group and the state record contains a field referred to as filter-mode which can only be of the INCLUDE type, containing only INCLUDE sources, or of the EXCLUDE type, containing only EXCLUDE sources. The rules that are transcribed below are applied when the network interface record must result from the combination of different records:

Rule 1. If any of the data sources of a group G1 is EXCLUDE, then the network interface will have an EXCLUDE filter-mode for the group G1 and the source list of the network interface is the intersection of the EXCLUDE source lists minus the sources of the INCLUDE lists.

Rule 2. If all the sources are INCLUDE type sources, then the network interface will have an INCLUDE filter-mode for the group G1 and the source list is the union of all the INCLUDE sources.

These rules are applied in a network interface of equipment operating as an IGMP proxy and receiving INCLUDE messages or EXCLUDE messages from different hosts or from different IGMP proxies located downstream from the network interface (i.e. in the direction going from the router to the hosts). These same rules are also applied in a network interface of equipment, such as a personal computer for example, provided with several sockets receiving different INCLUDE source or EXCLUDE source requests from different applications.

Channel (S, G) is used hereinafter, and according to the common nomenclature in SSM technology, to refer to the sending of source S of the multicast group G.

In the current state of the art routers using the IGMPv3 protocol store only the minimum multicast traffic information that they must transmit. This minimum information consists of storing, for each network interface of the router and multicast group, a state reflecting if, for a specific channel (S,G) or multicast group (*,G) there is at least one host interested in receiving the multicast traffic.

In a multicast system operating with the IGMPv3 protocol, different hosts connected directly to a single network interface of a router through a multiaccess network, such as an Ethernet network for example, can send different IGMP messages with multicast traffic requests referring to a single multicast group. Each of these IGMP messages contains its own INCLUDE type or EXCLUDE type sources. The router receiving these IGMP messages has to decide which multicast traffic it must send for each network interface and for each multicast group such that it meets all the traffic requests it has received through the IGMP messages. This problem is solved in the IGMPv3 protocol as follows: when an IGMPv3 router, which is initially transmitting multicast traffic from specific sources of a multicast group G, receives a new IGMPv3 message referring to the group G, it continues transmitting all the traffic from the sources that it was transmitting plus the traffic from the new sources requested in the new IGMPv3 message. Furthermore, to prevent indefinitely transmitting traffic from sources which no host wishes to receive, in specific cases the IGMPv3 router sends a Source-And-Group Specific Query type message to the multicast address G that all the hosts which are receiving traffic from group G listen to find out if there are still hosts interested in continuing to receive the multicast traffic from specific sources.

To explain the way of assembling messages in a proxy using the IGMPv3 protocol, the RFC 4605 specifications, defining the operation of the IGMP proxy, refer to section 3.2 of RFC 3376 defining the IGMPv3 protocol. The rules are the same as those which have been explained above to deduce the state of a network interface of a host based on several records. These rules adapted to the operation in an IGMP proxy are reproduced below:

Rule 1. For a specific network interface and multicast group, if any of the data sources of the received messages of the group is EXCLUDE, then an EXCLUDE type message is sent for the group and the source list of the message is the intersection of the EXCLUDE source lists minus the sources of the INCLUDE messages.

Rule 2. For a specific network interface and multicast group, if all the data sources of the received messages of the group are of the INCLUDE type, then an INCLUDE type message is sent for the group and the source list of the network interface is the union of all the INCLUDE sources.

Therefore, the method applied by an IGMP proxy consists of assembling the sources of the different messages of each multicast group received in each proxy network interface without taking into account which host sends the message: the proxy stores in which network interface the IGMP message has been received, but it does not store the identification of the host that has requested each source.

The same occurs in an IGMP router, the operation of which is explained in section 6 of RFC 3376. For each network interface of the IGMP router and for each multicast group, the IGMP router stores the information of the channels and multicast groups requested but it does not store the identification of the host requesting each channel or each multicast group.

The IGMP routers periodically send to the hosts messages referred to as Membership Query messages so that the hosts reply informing about the groups and sources from which they wish to receive multicast traffic. The hosts can also send messages to the router to request multicast traffic without waiting for the router to send a Membership Query message.

The routers execute the IGMP protocol in all the networks they are directly connected to. If a multicast router has more than one network interface connected to the same network it only needs to execute the protocol in one of the network interfaces.

For each network card or network interface, and for each multicast group, the IGMP routers store the information of the INCLUDE and EXCLUDE multicast sources in one record:

Record: (multicast-address, group-timer, filter-mode, {(source-address, source-timer)}) wherein

multicast-address is the multicast group;

{(Source-address, source-timer)} is a list of elements (source-address, source-timer), source-address being the source IP address and source-timer being a timer associated to the source;

filter-mode can be INCLUDE or EXCLUDE and it has the same operation as that described in RFC 3376: to indicate if the sources of the source list and timers are INCLUDE sources or EXCLUDE sources;

group-timer is a timer used as a mechanism for the transition of the filter-mode of a state record of the router from EXCLUDE mode to INCLUDE mode. When the group-timer of a specific multicast group and network interface reaches zero, the router assumes that there are no longer hosts with EXCLUDE filter-mode connected to the network interface and it switches to the INCLUDE mode.

The value of the timers gradually drops over time and if the router receives a Membership Report message from a host the router reinitiates the corresponding timers.

If the record has an INCLUDE filter-mode, the timers operate in the following manner: for a specific network interface, a specific multicast group and a specific included source-address, as long as the source-timer is greater than zero the router will continue transmitting through the network interface the multicast traffic from the channel (source, multicast group); when the source-timer reaches zero, the router will stop transmitting the traffic and will eliminate the source from the INCLUDE source list of that multicast group.

If the record has a EXCLUDE filter-mode the timers operate in a similar manner, but with the difference that the EXCLUDE sources are classified in two lists: a first list referred to as Requested List containing the sources the source-timer of which has a value greater than zero and a second list referred to as Exclude List containing the sources the source-timer of which has a value zero.

If a record has an EXCLUDE filter-mode for a specific multicast group, the router transmits all the traffic from all the sources of the multicast group except the EXCLUDE sources of the Exclude List.

The router also uses the timers to make sure that, after having sent a Group Specific Query message or a Group and Source Specific Query message, all the hosts have had enough time to reply to the message.

There are several reasons for the existence of a Requested List in IGMPv3. One of them is that in a network with several hosts sending messages to an IGMP router, it is possible that there could be a conflict between the requests of the different hosts. This occurs, for example, when a host requests traffic from a specific source and another host requests traffic excluding the source. For example, a host 4a sends a first EXCLUDE({S1},G1) message and another host 4b in the same Ethernet network then sends a second EXCLUDE({S1,S2,S3},G1) message to the same router. Upon receiving the second message, if the router places the sources (S1,S2,S3) of the second message in the Exclude List, the host 4a would stop receiving traffic from sources S2 and S3 that it wanted to receive because it wanted to receive all the traffic except the traffic from source S1. To avoid this problem, the IGMP router places in the Exclude List only the intersection of the set of sources of the new message with the set of sources that there were in the Exclude List before receiving the message. The remaining EXCLUDE sources go to the Requested List and, optionally, the router sends a Group-And-Source-Specific Query message to the hosts to ask if there is any host that is still interested in receiving traffic from sources S2 and S3 of group G1.

Table 1 (at the end of this document), extracted from the RFC 3376, summarizes the operation of a router according to the IGMPv3 protocol.

In Table 1, the first column “State 1” shows the initial state of the record of the IGMP router; the second column “Message” shows the content of a Membership Report message received by the IGMP router; the third column “State 2” shows the state of the record of the IGMP router after having received the Membership Report message; the fourth and last column “Actions” shows the actions that the IGMP router carries out after having received the Membership Report message. Table 1 contains 12 rows respectively corresponding to 12 examples which each illustrates the operation of the router according to its initial state (column 1) and according to the messages it has received (column 2). Each row of Table 1 is separated from another row by a dotted line.

Table 1 relates to a specific network interface of the IGMP router executing the IGMPv3 protocol and a specific multicast group G. Each network interface and multicast group G will have their own state records which will be affected by the messages that the IGMP router receives through the network interface referring to the group G.

The following nomenclature has been used in Table 1:

(A+B) means the union of the sets of sources A and B.

(A*B) means the intersection of the sets of sources A and B.

(A−B) means the set of sources A minus the sources of A that are also found in B.

INCLUDE (A) indicates that the IGMP router has a record with INCLUDE filter-mode with a set of sources A.

EXCLUDE (X,Y) indicates that the IGMP router has a record with EXCLUDE filter-mode because there are EXCLUDE sources, wherein:

X is the Requested List of EXCLUDE sources

Y is the Exclude List of EXCLUDE sources.

GMI is a parameter referred to as Group Membership Interval containing a value of time. A value of 260 seconds is used by default.

T (S) is the source timer of source S.

GT is the Group Timer, i.e. the timer of the record for switching from EXCLUDE mode to INCLUDE mode.

SEND Q(G, S) means that the IGMP router sends a Group-And-Source-Specific Query message to the hosts to check if there is still a host interested in receiving the sendings from sources S of multicast group G. When this action is carried out, the IGMP router also reduces the timers of the sources S to the LMQT value. If the IGMP router receives in response a message showing interest in any of the sources S, it then initializes the value of the timers of the sources, for which there is an interested host, to an initial value equal to GMI.

DEL(A) means that the IGMP router deletes from the record the sources of list A.

LMQT is a parameter referred to as Last Member Query Time containing a time value. It is the time a host has to reply to a Group-And-Source-Specific Query type message which has been sent by the IGMP routers. After this time, if no host replies that it is interested in receiving the channels specified in the message, the IGMP router stops transmitting them. The value of LMQT in the IGMPv3 protocol is 20 seconds by default.

The messages in column 2 of Table 1 are the six types of IGMP messages defined in the IGMPv3 protocol for indicating to the router the sources from which it wishes to obtain multicast traffic. The meaning of these six IGMP messages is described in RFC 3376 (chapter 4.2.12) and is as follows:

IS_IN (Z), IS_EX (Z) indicate that the network interface of the host that has sent the message has an INCLUDE or EXCLUDE filter-mode, respectively, for the sources of list Z.

TO_IN (Z), TO_EX (Z) indicate that the network interface of the host that has sent the message has switched the filter-mode from EXCLUDE mode to INCLUDE mode, or from INCLUDE mode to EXCLUDE mode, respectively, for the sources of list Z.

ALLOW (Z) indicates that the network interface of the host that has sent the message wishes to receive the traffic from the new sources of list Z. These sources are the sources that the network interface will add to its INCLUDE source list or they are the sources that it will delete from its EXCLUDE source list.

BLOCK (Z) indicates that the network interface of the host that has sent the message no longer wishes to receive traffic from the sources of list Z. These sources are the sources that the network interface will delete from its INCLUDE source list or they are the sources that it will add to its EXCLUDE source list.

It can be seen that the 12 rows of Table 1 correspond to the 12 possible combinations of an initial state record of the router (column 1) and of a type of IGMP message received (column 2).

The router consults the hosts by means of a Group-And-Source-Specific Query message (SEND messages in column 4 of Table 1) for checking if there is any host interested in receiving those sources the traffic of which was being initially transmitted (column 1 of Table 1) and no longer wishes to receive according to the sources indicated in the last received IGMPv3 message (column 2 of Table 1). This operation is inefficient because unnecessary Group-And-Source-Specific Query type messages are sent, and furthermore traffic is transmitted from sources that no host wishes to receive. Managing these situations in the twelve cases of Table 1 further involves enormous technical complexity.

### SUMMARY

According to one implementation a method of transmitting first content from a first host to a second host in a data network using a social network site in the data network is provided, the first host identifiable by a first IP address, the method comprising: receiving in the social network site a first unicast message from the first host related to a transmission of the first content from the first host, the first unicast message comprising the first IP address and a multicast group address to be used in the transmission of the first content; the social network site determining that a social relationship exists between the first host and the second host; and after determining that a social relationship exists between the first host and the second host the social network site sending a second unicast message to the second host indicating that the first host has or will initiate a transmission of the first content, the second unicast message comprising the first IP address and the multicast group address in a form useable by the second host to request and receive via the data network the first content in the form of multicast packets.

According to one implementation a method of transmitting first content from a first host to a second host in a data network using a social network site in the data network is provided, the first host identifiable by a first IP address, the method comprising: receiving in the social network site a first unicast message from the first host related to a transmission of the first content from the first host, the first unicast message comprising the first IP address; the social network site determining that a social relationship exists between the first host and the second host; the social network site selecting a multicast group address for the transmission of the first content and sending to the first host information about the multicast group address; and after determining that a social relationship exists between the first host and the second host the social network site sending a second unicast message to the second host indicating that the first host has or will initiate a transmission of the first content, the second unicast message comprising the first IP address and the selected multicast group address.

According to one implementation a method of transmitting first content from a first host to a second host in a data network using a social network site in the data network is provided, the first host identifiable by a first IP address, the method comprising: receiving in the social network site a first unicast message from the first host related to a transmission of the first content from the first host, the first unicast message comprising the first IP address; the social network site determining that a social relationship exists between the first host and the second host; after determining that a social relationship exists between the first host and the second host the social network site selecting a multicast group address for the transmission of the first content and sending to the first host information about the multicast group address; and after determining that a social relationship exists between the first host and the second host and selecting the multicast group address the social network site sending a second unicast message to the second host indicating that the first host has or will initiate a transmission of the first content, the second unicast message comprising the first IP address and the selected multicast group address.

According to one implementation a method of transmitting first content from a first host to a second host in a data network using a social network site in the data network is provided, the first host identifiable by a first IP address, the method comprising: receiving in the social network site a first unicast message from the first host related to a transmission of the first content from the first host, the first unicast message comprising the first IP address; the social network site determining that a social relationship exists between the first host and the second host; the social network site selecting a multicast group address for the transmission of the first content and sending to the first host information about the multicast group address; after determining that a social relationship exists between the first host and the second host the social network site sending a second unicast message to the second host indicating that the first host has or will initiate a transmission of the first content, the second unicast message comprising a selected source IP address and the selected multicast group address; receiving in the social network site the first content in the form of unicast packets; and transmitting from the social network site to a router in the data network that is accessible by the second host the first content in the form of multicast packets using the selected source IP address and the selected multicast group address.

According to one implementation a method of transmitting first content from a first host to a second host in a data network using a social network site in the data network is provided, the first host identifiable by a first IP address, the method comprising: receiving in the social network site a first unicast message from the first host related to a transmission of the first content from the first host, the first unicast message comprising the first IP address; the social network site determining that a social relationship exists between the first host and the second host; after determining that a social relationship exists between the first host and the second host the social network site selecting a multicast group address for the transmission of the first content and sending to the first host information about the multicast group address; upon or after the social network site sending to the first host information about the multicast group to be used in the transmission of the first content, the social network site sending a second unicast message to the second host indicating that the first host has or will initiate a transmission of the first content, the second unicast message comprising a selected source IP address and the selected multicast group; receiving in the social network site the first content in the form of unicast packets; transmitting from the social network site to a router in the data network that is accessible by the second host the first content in the form of multicast packets using the selected source IP address and the selected multicast group address.

According to one implementation a method of transmitting first content from a first host to a second host in a data network using a social network site in the data network is provided, the first host identifiable by a first IP address, the method comprising: receiving in the social network site a first unicast message from the first host related to a transmission of the first content from the first host, the first unicast message comprising the first IP address and a multicast group address to be used in the transmission of the first content; the social network site determining that a social relationship exists between the first host and the second host; after determining that a social relationship exists between the first host and the second host the social network site sending a second unicast message to the second host indicating that the first host has or will initiate a transmission of the first content, the second unicast message comprising a selected source IP address and the multicast group address; receiving in the social network site the first content in the form of unicast packets; transmitting from the social network site to a router in the data network that is accessible by the second host the first content in the form of multicast packets using the selected source IP address and the selected multicast group address.

According to one implementation a method of transmitting multicast packets from a first host to a second host in a data network using a social network site in the data network, the first host identifiable by a first IP address, the method comprising: receiving in the social network site a first unicast message from the first host related to a transmission of the first content from the first host, the first unicast message comprising a second IP address and a multicast group address to be used in the transmission of the first content; the social network site determining that a social relationship exists between the first host and the second host; after determining that a social relationship exists between the first host and the second host receiving in the social network site from the first host encapsulated unicast packets comprising the multicast packets; after determining that a social relationship exists between the first host and the second host the social network site sending a second unicast message to the second host indicating that the first host has or will initiate a transmission of the first content, the second unicast message comprising the second IP address and the multicast group; and the social network site removing the encapsulation of the unicast packets comprising the multicast packets and transmitting the multicast packets from the social network site to a router in the data network using the second IP address as source IP address of the multicast IP packets and the selected multicast group as destination IP address of the multicast IP packets.

It is important to note that the numerous implementations disclosed and contemplated herein are not limited to any particular multicast routing protocol. The IGMPv3 and PIM-SM protocols are used herein as examples.

A site, as used herein, may refer to a computing device or a set of computing devices connected to a data network capable of exchanging information and services with other sites and computer devices through the data network. When the data network comprises the Internet, sites may be associated with a Uniform Resource Identifier (URI) to provide other computing devices and sites with access to data and services without entering the IP address of the site in the form of numbers. Communications between a site and another computer or site may use different protocols such as IPv4, IPv6 TCP/IP, UDP, RTP, RTSP, http, HTTPS, MOBILE IPv4, MOBILE IPv6, IPSEC, SNMP, SOAP, XML, IGMP, and others. A social network site may be, for example, Facebook.

### BRIEF DESCRIPTION OF THE DRAWINGS

Other advantages and features of the invention can be seen in the following description in which, with a non-limiting character, some implementations of the invention are referred to in relation to the attached drawings.

FIG. 1 shows a basic example of a multicast a data network.

FIG. 2 shows an example of computing devices that communicate in a network with a social network site.

FIG. 3 shows an example of a multicast network with a social network site.

FIG. 4 shows an example of a multicast tree.

FIG. 5a shows an example representation of users and relationships between users.

FIG. 5b illustrates communications according to one implementation.

FIG. 6 illustrates a multicast network according to one implementation.

FIG. 7 illustrates communications according to one implementation.

FIG. 8 illustrates a multicast network according to one implementation.

### DETAILED DESCRIPTION

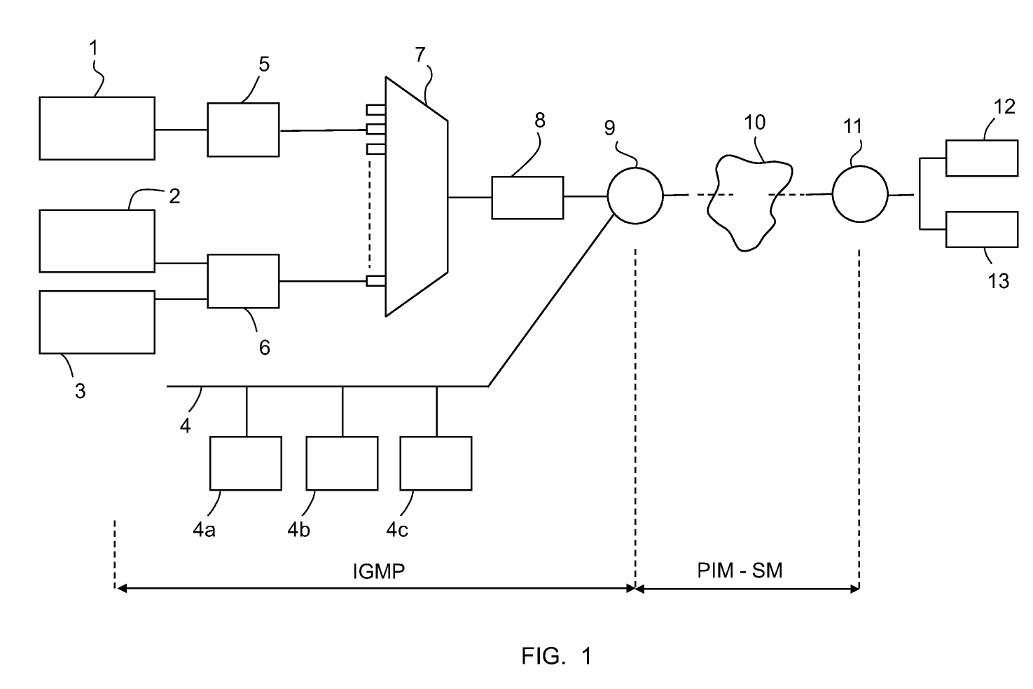

FIG. 1 shows a basic example of a multicast system in a data network. In this example, six hosts 1, 2, 3, 4a, 4b, 4c are connected to the data network. Hosts 1, 2 and 3 are connected through CPE 5, 6 (CPE: Customer-Premises Equipment). A CPE is a connection terminal to the network that is located on the subscriber access line side, which is communicated for example by means of a DSL (Digital Subscriber Line) modem. The hosts 2 and 3 are both connected to a single CPE 6 of a subscriber line. CPEs 5, 6 are connected to a DSLAM 7 (DSLAM: Digital Subscriber Line Access Multiplexer) which directs traffic from the different CPEs 5, 6 through a switch 8 to a router 9 which is in turn connected to an IP network 10. Another router 11, which transmits the data packets sent by sources 12, 13, is connected to another point of the IP network 10. The hosts 4a, 4b, 4c are connected directly to a single network interface of the router 9 through a multiaccess network which in this case is an Ethernet network represented by line 4.

For clarity's sake, FIG. 1 shows a single group formed by several hosts 1, 2, 3, 4a, 4b, 4c connected to a router 9, and a single group of sources 12, 13 connected to a router 11. Of course, a multicast system is in reality made up of a large number of these assemblies and groups.

The particular distribution of the different network equipment in FIG. 1 is also a very simple case the only purpose of which is to illustrate the following explanations.

FIG. 1 also shows the scope of each of the IGMP and PIM-SM protocols: the IGMP protocol is applied to communications between the receiving hosts and the routers, through the CPEs and the DSLAMs, whereas the PIM-SM protocol is applied to communications between different routers through the IP network. The router 9 is located in the border between these two types of communications and uses both protocols. The router 9 treats the information contained in the IGMP messages reaching it from the hosts and sends, towards other routers of the network, such as the router 11 for example, corresponding PIM-SM messages so that the routers transmit to it the channels requested by the hosts in the IGMP messages.

It has been assumed in this example that the routers operate with the IPv4 version of the IP protocol and therefore the system uses the IGMP protocol. However, the reasons set forth are also applied to a system using the MLD protocol (used in the IPv6 version of the IP protocol).

The CPEs and the DSLAMs are equipment that can carry out an IGMP proxy function consisting of receiving several IGMP requests and assembling them to reduce the volume of IGMP messages which are sent to the router. This operation is described in the RFC 4605 specifications of the IETF mentioned above.

A basic operation of the multicast system shown in FIG. 1 is as follows.

Hosts 1, 2, 3 send IGMPv3 messages to CPEs 5, 6 in which they identify the multicast address of a multicast group and the source addresses of the multicast group from which they wish to receive a data sending. These IGMP messages are INCLUDE type or EXCLUDE type. The CPEs receiving several IGMP messages from different hosts, as is the case of CPE 6 in the example of FIG. 1, assemble these IGMP messages to send DSLAM 8 a single IGMP message. For its part, DSLAM 7 receives IGMP messages from different CPEs, in this case CPEs 5 and 6, and assembles them to send to router 9, through a switch 8, an IGMP message in which only the INCLUDE or EXCLUDE sources are indicated for each multicast group. hosts 4a, 4b, 4c are connected directly to router 9 through the Ethernet network 4, whereby they send directly to the router 9 their IGMP messages.

CPE 6 and DSLAM 7 operate as an IGMP proxy, i.e. as intermediate equipment between the host and the IGMP router receiving IGMP traffic requests through its network interfaces connected to the host or to other IGMP proxies, assembling the information and sending a summarized IGMP message through the network interface connecting the IGMP proxy with the IGMP router. An IGMP proxy behaves like an IGMP router in its communications with the host and behaves like a host in its communication with an IGMP router. Therefore, as seen from DSLAM 7 CPE 6 is equivalent to a host. Likewise, as seen from router 9 DSLAM 7 is equivalent to a host.

CPE 5, however, is connected to a single host 1 and transmits towards the router 9 IGMP messages corresponding to the IGMP messages sent by the host.

DSLAM 7 therefore receives IGMP messages from the host 1 which pass through CPE 5 and IGMP messages from CPE 6 which, seen from DSLAM 7, behaves like a host. For its part, router 9 receives IGMP messages directly from hosts 4a, 4b, 4c and IGMP messages from DSLAM 7 which, seen from the 9, behaves like a host.

Router 9 receives IGMP messages sent by DSLAM 7 through switch 8 and by hosts 4a, 4b, 4c directly and communicates with other IP network routers using the PIM-SM protocol for communicating with router 11 and setting up routing through the IP network making the data sent by the sources specified in the IGMP message received by router 9 reach router 9 from router 11.

Some social networks have developed tools to allow developers to integrate their websites with the social network sites. Facebook Platform, Google Friend Connect, and the Twitter API are examples of these tools.

A description of these tools may be found in the book “The Developer's Guide to Social Programming. Building Social Context Using Facebook, Google Friend Connect, and the Twitter API”, Mark D. Hawker, published by Addison Wesley in August 2010.

Today many of the Web's most popular sites are linked to Facebook, through Share or Like or Connect buttons.

Also, some social networks have been designed to be used with smartphone software applications, usually called “apps”. Foursquare is an example of a successful social network application for smartphones that uses geolocation to offer some social network features by establishing a connection between the Foursquare app executing in the smartphone and the Foursquare social network site.

Recently, Facebook has added its own geolocation features in its smartphone apps to compete with new successful social networks such as Foursquare.

Hereunder exemplary implementations that establish communications with different types of social networks are disclosed.

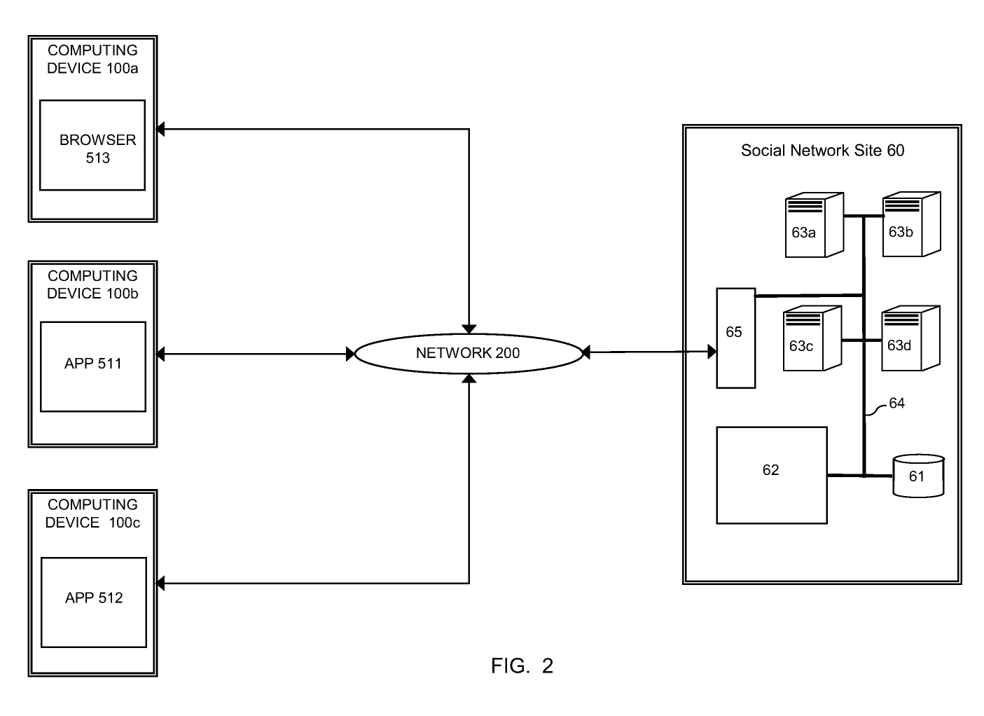

FIG. 2 shows an example implementation of a social network site 60, hereafter referred to as social site 60.

In FIG. 2, three computing devices 100a, 100b and 100c, use a browser or Internet browser-type program 513, an application APP 511 and an application APP 512 respectively, to transmit and receive data from the social site 60 or between them by means of a data network 200, such as the Internet. In the example shown in FIG. 2, the social site 60 has four servers 63a 63b, 63c and 63d connected by a data network 64. The site 60 is connected to the data network 200 by one or more network devices 65 (only one shown in FIG. 2) such as routers, switches and firewalls. It also has an application 62, for example an application that displays a web interface. The social site 60 also has data storage means 61.

The following describes an implementation of the social site 60. However, other social network implementations are also possible, using a different number of elements and distributing the various functions between different elements in different ways.

In some implementations, the computing devices 100a, 100b and 100c may use a browser-type program or an application to communicate with the social site 60, for example by means of application 62, which allows users to register and interact with one another. The application 62 may, for example, display different types of data for each user, including profile information, or relationships between a user and others. For example, the relationships that the user of computing device 100a has with users of computing devices 100b and 100c.

In some implementations, the application 62 is associated with a website which is usable from a browser, such as the browser 513. In one implementation application 62 may use other communication protocols (e.g., HTTP, XML, web services, etc.) to communicate with the computing device, for example to communicate with the application APP 511.

In one implementation, the server 63a performs the functions of registering, authenticating and authorizing the computing devices and/or users who use computing devices to allow them to connect and communicate with the social site 60 to transmit and receive data to the social site 60 and to other computing devices.

In some implementations the computing devices may transmit to the social site 60 data that comprises information that identifies the computing device 100a, 100b and 100c or identifies the user in the database 61. For example, the computing device user may have registered at a web page of the web server 63a of site 60, transmitting registration data which are stored in the database 61. Upon registration, the user can choose identifier data, such as for example the e-mail address or other identifier data, and a password that allows the user, for example, to access his or her data and modify them.

Once a user has registered on the social site 60 he or she may transmit data, such as personal information, to the social site 60 in the form of text messages, pictures, photos, videos, audio, URL or URI type web links, geographic data, geographic coordinates such as GPS, location data, information on events and other social data that the social site 60 receives and stores associated with the user in the database 61.

In some implementations, the server 63b executes a software program editor of social relations which it receives from the computing devices 100a, 100b and 100c, data indicating a type of relationship between users of computing devices and the software program which stores in storage means 61 data regarding the type of relationship between the users. The editor of social relations software can also generate and send communications to the computing devices to confirm the type of social relations.

For example, users of computing devices 100a and 100b can register on the site 60 using the application 62 and select the names user100a and user100b. Once registered, the user100a can request to establish a relationship with the user100b using the software program editor of social relations of the server 63b. The server 63b may send a communication or message to the user100b so that this user confirms the relationship with the user100a. If the user100b responds with a message or communication indicating that he or she accepts the type of social relationship created by user100a, the server 63b stores the social relationship in a database or storage means 61.

The type of relationship established between user100a and user100b can be, for example, being friends, belonging to the same club, team, gymnasium or school, having a subject, class or profession in common, having planned to attend or having attended to an event such as a sporting or religious event, a conference or trade show, having common hobbies or tastes, such as on a type of music or film, etc.

Each type of social network can establish different types of relationships between different social network users.

In some social networks, like Twitter, a user can publish in the network short messages, such as for example up to 140 characters, and users who wish to receive these messages “subscribe” to the user who publishes the messages to receive them. At the same time the user who publishes the messages may also be registered to receive messages from other users. When a user has subscribed to receive messages, a “follower” type of social relationship is stored in the social network.

New types of social relationships between users can be defined in the program that runs on the server 63b assigning to each new type of relationship a unique identifier (for example an integer or alphanumeric code) and a description of the type of social relationship while storing that information in a database of site 60.

In some implementations, the server 63c executes a software program that lets one see relationships between users and their associated data, such as photographs, videos and personal profile data of users who are linked between them. The server 63c also allows other functions for users to interconnect, such as users sending messages, emails or establishing voice communications, such as voice over IP (VoIP) or video communications such as videoconferences.

In some implementations the server 63d runs a program or software programs that allows the social site 60 to communicate with a software application running on a computing device.

The database or storage means 61 can use any storage device or storage means to store the information for each user and their relationships and communications with other users. Moreover, the data may be stored in one or more remote locations.

In some social networks, social network members can join or create relationships based on groups. These groups may include people with the same interests, such as a football team, a band, a personal hobby, a brand of clothing, etc. Each user can create his own group with those who share the same interests.

Some implementations enable the creation of various types of groups with different privacy settings and accepting new members in the group.

Some implementations have an open public group of users who have a common interest or who want to show their affinity with the aim of the group. The open public group interactions are typically public and visible in search engines pages, the content can be viewed without being a member of the page. Non-members typically cannot add content.

A “page” does not follow the typical format of the group because there are no members. Joining a “page” is typically accomplished by simply clicking on an icon on the page itself. After joining a page a member is generally free to add content.

Other implementations enable the creation of groups that have administrators and members.

The following are examples of groups:

Open group: Any user can join this group and invite others to do so, in this way, any user can view the information and content of the group and add their own content. Joining is automatic, so no-one needs to accept or confirm the request to join the group.

Closed or Private Group: For a new member to join the group, the group administrators must approve an application for membership. The group appears in the search engine results but the contents cannot be viewed. Any user can view the description of the group, but only members may view the contents and add new content.

Secret Group: The group does not appear as the result of a search or on the profiles of the group members. Only people who receive an invitation from a group member may join. Only members can view group information and content and add new content to the group.

In some implementations, the administrator or administrators can change the settings of the groups so that the restrictions respect to the possibility of publishing content can vary.

The form for the creation of a group typically includes information fields such as group name, description and some relevant searchable data. In some situations, when the social site group includes an administrator, the administrator can delete or report inappropriate content.

According to other implementations the social network site has functionalities similar to that of Twitter and enables the creation of a user to publish content, for example, in the form of short messages. In turn, a user can be a “follower” of another user, thus creating a link between the two of them allowing him/her to receive content that this user posts and view other users' comments to that content

A user may directly become a “follower” of another user, without the need for the user followed to have to decide whether or not to accept that relationship. However there may be settings that can protect publications, so that only accepted users allowed to follow these publications may see them.

User messages can be searched based on keywords or “topics”, such as, for example. messages that talk about a theme or content on a single common interest, similar to what a group would be.

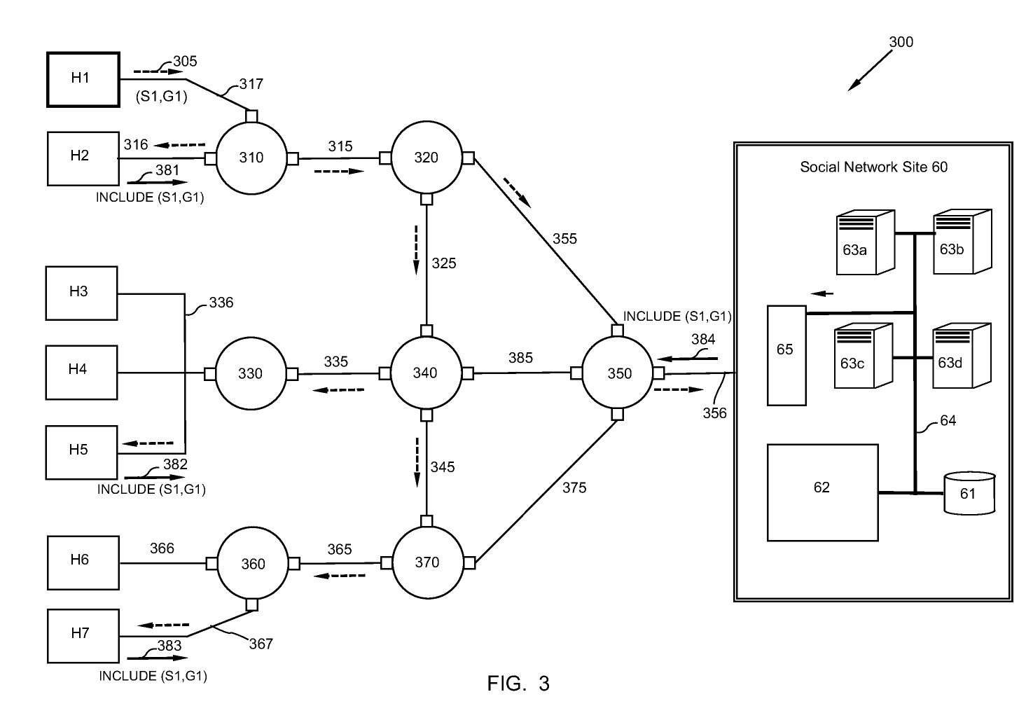

FIG. 3 shows an example of a data network according to some implementations. In the example of FIG. 3 there are seven routers identified in the figure as 310, 320, 330, 340, 350, 360 and 370. These routers can implement different multicast routing protocols such as protocols IGMPv1, IGMPv2, IGMPv3, MLDv1, MLDv2, PIM-SM and PIM-DM and unicast routing protocols such as BGP, RIP, RIPv2, RIPng, EIGRP, OSPF, OSPFv2, OSPFv3 IS-IS, MB-BGP for IPv6 or any other unicast or multicast protocol used in routers.

In the example of FIG. 3 there are seven hosts indicated as H1, H2, H3, H4, H5, H6 and H7. The hosts can be any type of computing device such as a computer, a laptop, a PDA, a cell phone, a smartphone, a set-top-box, a television, a smart-TV, a tablet such as an iPAD-type tablet, a media player such as an iPod-type player, or any other type of computing device

Router 310 communicates with the hosts H1 and H2 through data networks 317 and 316, respectively. The router 330 communicates with the hosts H3, H4 and H5 by a multiaccess data network 336. The router 360 communicates with the hosts H6 and H7 using data networks 366 and 367, respectively. Social site 60 communicates with the router 350 through data network 356.

The routers shown in the FIG. 3 also communicate with each other through data networks. The router 310 communicates with the router 320 through data network 315. The router 320 also communicates with the routers 340 and 350 through data network 325 and 355, respectively. The router 340 also communicates with the routers 350, 370 and 330 through communications 385, 345 and 335 respectively. In addition there is a communication 375 between routers 350 and 370 and another communication 365 between routers 360 and 370.

In different implementations the data networks that connect the different hosts, different routers and the social site 60 may be different data networks such as DSL or ADSL networks, Ethernet data networks via cable or fibre optics, wireless data networks such as WIFI, WIMAX, wireless networks such as UMTS networks, 3GPP, 3GPP2, 4G, LTE or any other type of data network.

In the following explanations IP addresses are described without distinguishing between IPv4-type IP addresses and IPv6-type IP addresses. In some implementations the equipment in network 300 use the same type of IP address and packets, either IPv4 or IPv6. In some implementations the equipment of FIG. 3 use IPv4 addresses for some hosts and/or routers and IPv6 addresses in other hosts and/or routers. Explained below is an example of an implementation with hosts using different IP address.

Users of the hosts H1, H2, H3, H4, H5, H6 and H7 are referred to as user1, user2, user3, user4, user5, user6 and user7, respectively. Once a user has registered on the social site 60, he/she may use different methods to establish communications with the social site 60, such as by use of a computer, mobile phone, iPAD tablet or any other device with compatible software with the social site 60, such as a browser or Internet browser or an app or software application that allows communication with the social site 60.

User1 using the host H1 has stored in the social site 60 a social relationship with user2, user5 and user7 that use the hosts H2, H5 and H7 respectively. This social relationship can be, for example, a “friends”-type relationship on the Facebook network, or a “followers”-type relationship on the Twitter social network where user2, user5 and user7 want to receive the information transmitted by user1.

In the example of FIG. 3, the user1 transmits multicast data packets using the channel (S1, G1), where S1 is the source IP address of the multicast packets and G1 is the destination IP address of the multicast packets corresponding to an IP address within the range of multicast addresses. In FIG. 3 the transmission of multicast channel packets (S1, G1) from the host H1 is indicated by the dashed arrow 305.

If host H1 is not using a NAT (Network Address Translator) or NAPT (Network Address and Port Translator), then the IP address S1 is the IP address of the host H1. Otherwise, that is if the host H1 uses a NAT or NATP-type device (not shown in FIG. 3) to communicate with the router 310, then S1 is the “external” IP address of host H1 (the source IP address used by the multicast IP packets transmitted by the host H1 reaching the router 310 after passing through the NAT or NAPT).

Multicast group G1 used by the host H1 may be chosen in several ways. In one implementation, host H1 establishes a unicast communication with social site 60 to indicate that it is starting a data transmission and the social site 60 selects the multicast group G1 and transmit the information about G1 to the host H1.

In another implementation, host H1 chooses the multicast group G1 and establishes a unicast communication with the social site 60 to indicate that it will begin transmitting multicast data using the multicast group G1.

In one implementation, when the social site 60 receives the unicast communication from host H1, the social site 60 sends a message, for example by IGMPv3 or MLDv2 protocol, to the nearest IGMP router, for example router 350, to request to receive multicast channel traffic (S1, G1). This message is shown in FIG. 3 by the element 384 indicated by an arrow and the words “INCLUDE (S1, G1)”

In one implementation, the social site 60 stores the information of users who have a relationship with user1, for example, user2, user5 and user7, and detects whether these users are connected to the social site 60 from a computer, for example by detecting if they are logged on with their code or name and password, and social site 60 transmits information, for example using a unicast data or message, to those users to indicate that user1, with whom they have stored a particular social relationship in the social site 60, will start multicast data transmission or has already started it using the multicast channel (S1, G1).

In this way the hosts H2, H5 and H7, used by user2, user5 and user7 respectively, receive multicast channel information (S1, G1) used by the host H1 to transmit multicast data and they can send messages to the nearest router, for example in the IGMPv3 or MLDv2 protocols to request to receive multicast channel traffic (S1, G1). These messages are shown in the figure by the elements 381, 382 and 383 indicated by an arrow and the words “INCLUDE (S1, G1)”.

Routers in the example in FIG. 3 can use any multicast routing protocol between routers to create the multicast trees that can transmit traffic from the host H1 to the hosts which have requested the multicast channel traffic (S1, G1).

In one implementation the multicast routing protocol between routers is the PIM-SM protocol and the routers receiving the messages from the hosts requesting multicast channel traffic send a JOIN (S,G) type PIM-SM message in the direction of the host H1 to create an SPT-type multicast tree (Shortest Path Tree) that transmits multicast traffic from the host H1 to hosts H2, H5 and H7.

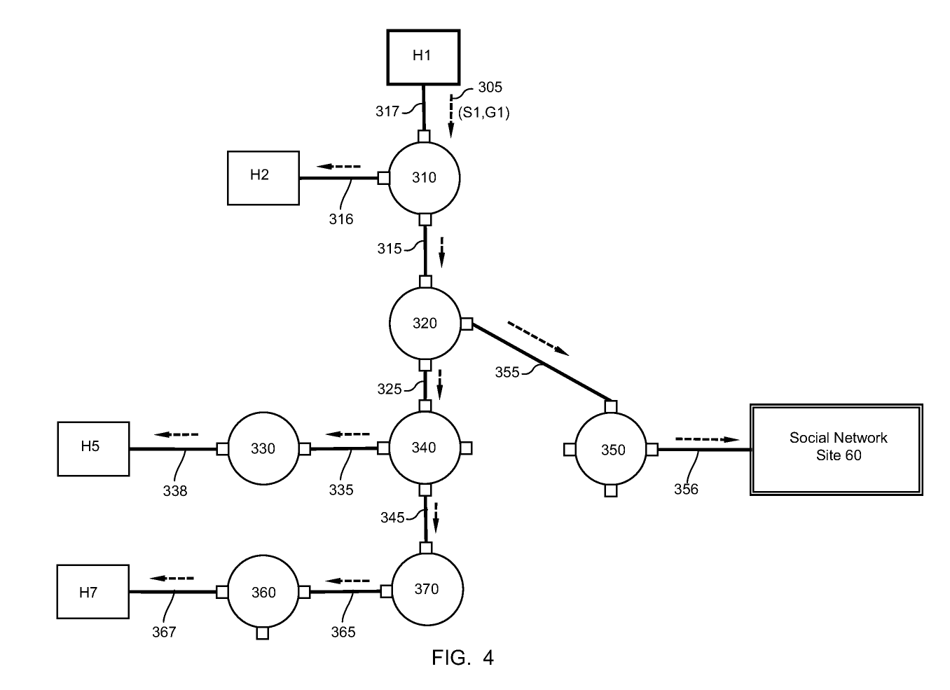

FIG. 4 shows an example of a multicast tree. In FIG. 4 the transmission of multicast data packets is indicated by arrows with dashed lines.

Host H1 transmits the IP packets of the multicast channel (S1, G1) to the router 310 as indicated by arrow 305.

Host H2 receives (S1, G1) multicast channel packets through the data network 316 that connects with the router 310.

The host H5 receives (S1, G1) multicast channel packets through the path formed by the data networks 338, 335, 325, 315 and 317 and routers 330, 340, 320 and 310.

The host H7 receives (S1, G1) multicast channel packets through the path formed by the data networks 367, 365, 345, 325, 315 and 317 and routers 360, 370, 340, 320 and 310.

Social site 60 receives the multicast channel packets (S1, G1) through the path formed by the data networks 356, 355, 315 and 317 and routers 350, 320 and 310.

In other implementations, the data transmission may use other types of multicast trees or multicast routing protocols.

In an implementation using the PIM-SM protocol, a router may act as Rendezvous Point router of the PIM-SM protocol and uses a RPT-type multicast tree that transmits traffic to other routers to reach hosts that have requested it, for example by IGMPv3 or MLDv2 messages.

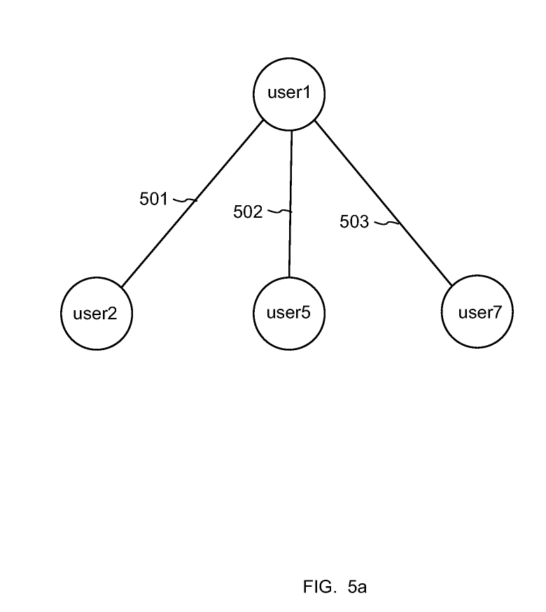

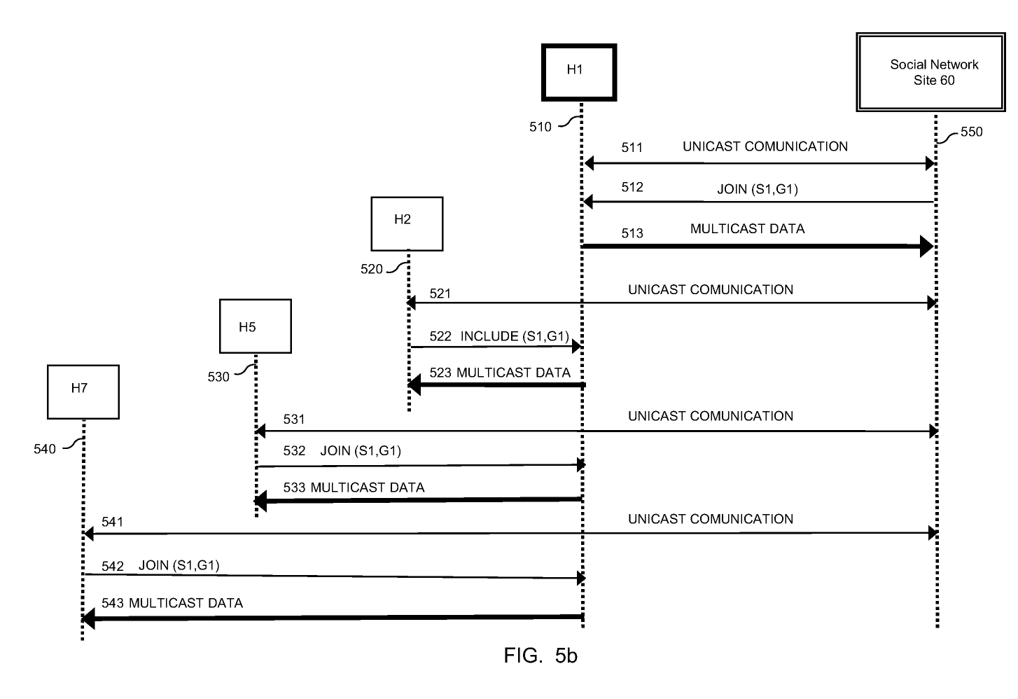

FIG. 5a shows in a graphic way the information stored by social site 60 on user1, user2, user5 and user7.

In the example of FIG. 5a, users are represented by nodes in the shape of circles and relationships between users are represented by lines connecting users, however the social site 60 may store these relationships using any storage device such as a relational database.

The graph in FIG. 5a shows how user1 stores three social relationships 501, 502 and 503 with user2 user5, and user7, respectively.

The type of social relationships may be, for example, that user2, user5, and user7 are “followers” of user1 and are interested in receiving the information transmitted by user1. Other types of social relations are also possible.

FIG. 5b shows an example of some implementations in which user1 sends content using multicast packets and users who have a social relationship with user1 stored in the social site 60 can receive that content as multicast packets. The content sent by the host H1 may be any type of data such as, for example, text, voice, audio, images, video and combinations thereof.

In FIG. 5b, communications between hosts H1, H2, H5 and H7 and the social site 60 are indicated by horizontal arrows starting or ending at the dashed lines 510, 520, 530, 540 and 550, respectively.

The origin of the horizontal arrow indicates the origin of the IP packet. For example, a horizontal arrow, like for example 522, starting at the dashed line 520 represents a transmission of IP packets whose source is host H2.

The bidirectional arrows represent transmission of IP packets in both directions from the ends of the two-way arrow.

For clarity, in FIG. 5b multicast communications in the form of transmission of multicast IP packets are indicated by thicker arrows.

In some implementations, when user1 wants to start a multicast data transmission using host H1, host H1 establishes a unicast communication 511 with the social site 60. In one implementation, in the communication 511, the social site 60 chooses the multicast group G1 and transmits information/data about or comprising G1 to the host H1. In another implementation, user1 and/or host H1 selects the multicast group G1 and host H1 transmits information/data about or comprising G1 to social site 60 by communication 511. The arrow 511 is a two-way arrow, indicating that data packets can be transmitted in both directions, for example by using the TCP-IP protocol.

In some implementations, host H1 transmits to social site 60 second information data or parameters associated with the multicast data transmission, such as, for example, one or more of the UDP port number, protocol to be used, codec type, number of streams to be transmitted, an identifier for each stream and any other data associated with the multicast data transmission to be undertaken by host H1. For example, host H1 can transmit this second information data using the SDP protocol (Session Description Protocol). In another implementation it is the social site 60 which transmits to the host the second information data or parameters associated to the multicast data transmission or to be used in multicast data transmission

The unicast communications in FIG. 5b may use any protocol used in unicast communications such as IP, TCP-IP, UDP, HTTP, HTTPS, SDP, XML, web services, RTSP, SIP, SOAP or others.

In one implementation, once the social site 60 knows the multicast channel (S1, G1) which the host H1 will use for multicast data transmission, the social site sends a message, for example using the IGMPv3 or MLDv2 protocols, to receive the multicast traffic transmitted by host H1.

The router 350 which communicates with the social site 60 by the data network 356 receives the IGMPv3 or MLDv2 message from social site 60 and sends a message in a multicast routing protocol to receive multicast channel traffic (S1, G1) that the host H1 transmits or is going to transmit.

In one implementation, the router 350 uses the PIM-SM protocol and sends a JOIN (S1,G1) type PIM-SM message in the direction of host H1. This message is shown in FIG. 5b by the arrow 512.

The arrow 512 points to the host H1 because the JOIN (S1,G1) type PIM-SM message is sent to the IP address of the host H1, i.e. the address S1. However, the PIM-SM message does not necessarily need to reach the host H1 but may go in that direction until it finds a router that receives (S1, G1) multicast channel traffic.

The thicker arrow 513 represents the multicast packet traffic of the multicast channel (S1, G1) reaching the social site 60 from the host H1, for example by the SPT multicast tree shown in FIG. 4.

In one implementation, the social site 60 may store the content transmitted by host H1 through the multicast channel (S1, G1), for example to later transmit such content to hosts. For example, the content may be stored and later transmitted to users who were not logged-in to the social site at the time the content was originally transmitted. In one implementation the transmitted content is processed or stored by use of the social site 60 in a manner to allow lawful interception of the communications.

In some implementations, when the social site 60 receives the communication data 511 and knows the multicast channel (S1, G1) to be used by the host H1 and the second information data associated with the multicast channel (S1,G1), the social site 60 transmits this information to the host of the users who have stored on the social 60 site a certain social relationship with the user1, such as user2, user5, and user7 shown in FIG. 5a. In some implementations, the social site 60 only sends this information to host of users that are currently connected with the social site 60.

In one implementation, the social site 60 stores the IP address of the hosts H2, H5 and H7 associated with user2, user5 and user7, respectively, and transmits the multicast channel information (S1, G1) and the second information data or parameters associated with the multicast transmission to host H2, H5 and H7, establishing the unicast communications shown in FIG. 5b by the arrows 521, 531 and 541, respectively. In this way user2, user5 and user7 who have stored on the site 60 a specific social relationship with user1 can detect the start of H1 host multicast transmission and send routing messages to request to receive multicast channel traffic (S1, G1).

These routing messages can be, for example, IGMPv3 or MLDv2 messages sent by the hosts H2, H5 and H7 to the nearest router 310, 330 and 360 respectively to receive multicast channel traffic (S1, G1). Request messages of multicast traffic are shown in FIG. 5b by the arrows 522, 532 and 542.

The arrow 522 includes a message “INCLUDE (S1, G1)” representing a message to request multicast channel traffic (S1, G1), for example through the protocols IGMPv3 or MLDv2. The router 310 can transmit multicast channel traffic (S1, G1) received from the host H1 to host H2 without using a multicast routing protocol between routers.

In some implementations, the hosts H5 and H7 can send IGMPv3 or MLDv2 messages to request multicast channel traffic (S1, G1). The router that receives these messages IGMPv3 or MLDv2 may turn them into PIM-SM messages which it sends towards the host H1 until reaching a multicast router in the multicast tree that receives multicast channel traffic (S1, G1).

The routers 330 and 360 that receive messages from the host H5 and H7 can use a multicast routing protocol between routers and send a JOIN (S1,G1) type PIM-SM message towards the host H1 to receive multicast traffic, for example using the multicast tree shown in FIG. 4. The arrows 532 and 542 include a JOIN (S1,G1) message that represent these PIM-SM messages going in the direction of the host H1 to receive multicast channel traffic (S1, G1).

In the example of FIG. 5b, the transmission of the multicast data is represented by arrows 513, 523, 533 and 543.

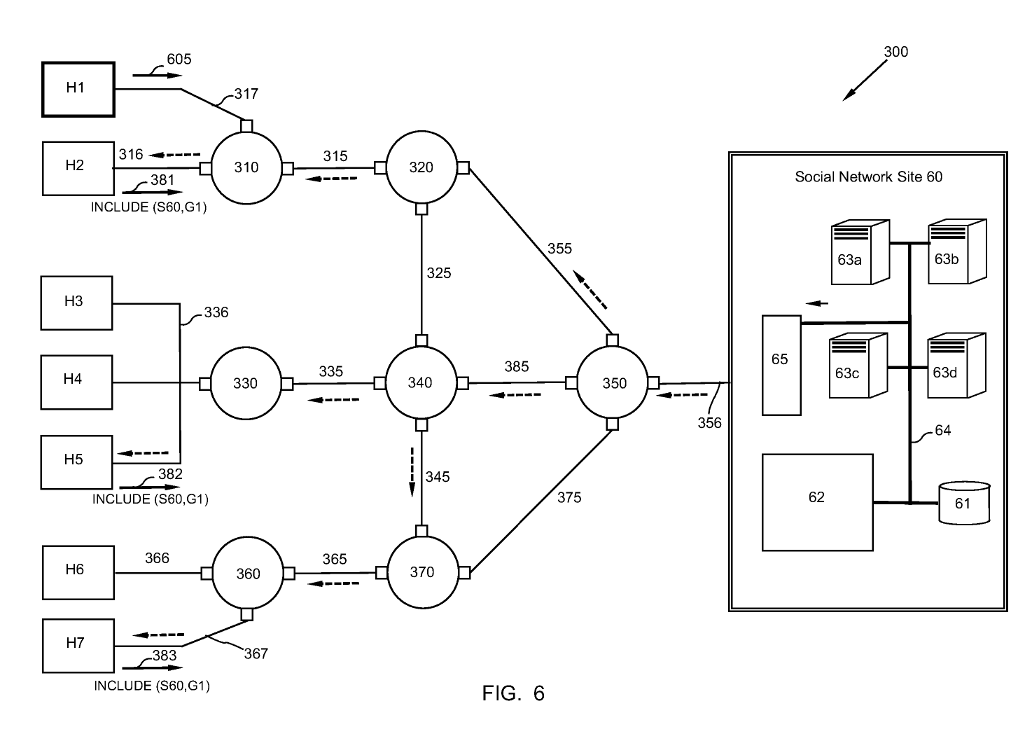

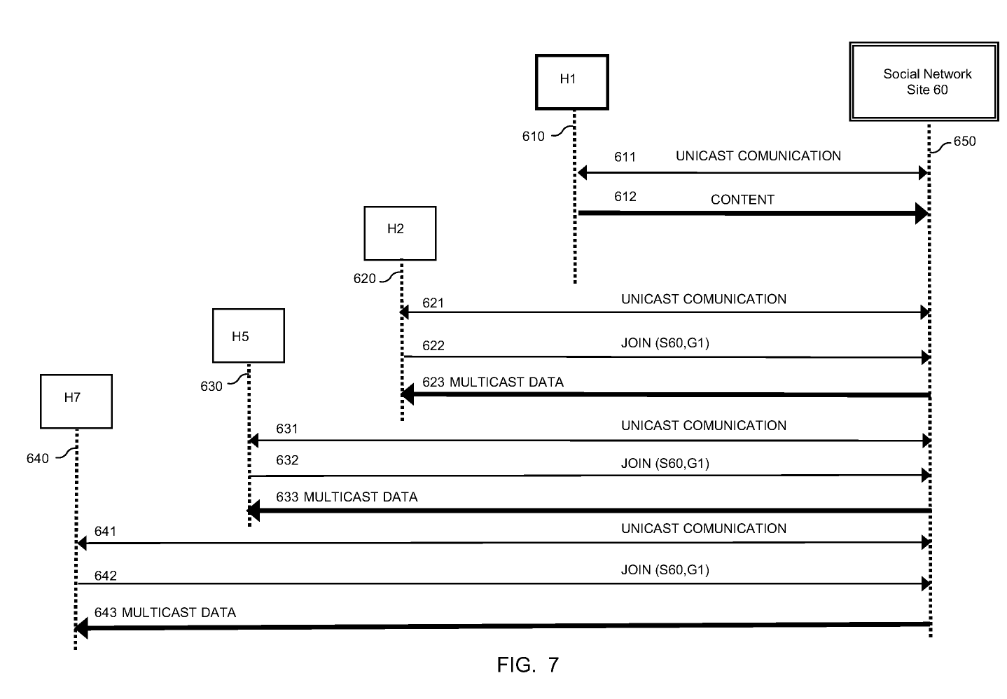

In the example of FIGS. 6 and 7, the host H1 first transmits content to the social site 60 using unicast packets and the social site 60 uses multicast packets to transmit the content to host H2, H5 and H7. As discussed above, the content sent by the host H1 may be any type of data such as, for example, text, voice, audio, images, video and combinations thereof.

FIG. 6 shows arrow 605 representing the transmission of content using unicast packets from host H1 to the social site 60 and the arrows with broken lines represent the transmission of the content using multicast packets from the social site 60 to the hosts H2, H5 and H7.

In the example of FIG. 6, the host H2 receives the content via multicast packets using data networks 356, 355, 315 and 316 through routers 350, 320 and 310. Host H5 receives the content via multicast packets using networks 356, 385, 335 and 336 through routers 350, 340 and 330. Host H7 receives the content via multicast packets using data networks 356, 375, 365 and 367 through routers 350, 370 and 360.

FIG. 7 shows examples of the different communications established between the hosts H1, H2, H5, H7 and social site 60.

In some implementations the multicast group G1 and the second data information or parameters associated with the multicast transmission are selected by the host H1 and the information of the selected multicast group and the second data information is transmitted from the host H1 to the social site 60 using communication 611.

In some implementations, the social site selects the multicast group G1 and the second data information or parameters associated with the multicast transmission and transmits this information to the host H1 using communication 611.

Subsequently, host H1 sends the content to social site 60 via communication 612 using unicast packets. The social site 60 may store the content for it to be transmitted later or for other reasons such as for the lawful interception of communications.

In one implementation the social site 60 transmits the content via multicast channel (S60,G1) packets which have a source IP address S60 that is topologically correct in the network 356 that connects the social site 60 with the router 350.

In some implementations, when the social site 60 knows which is the multicast channel (S60,G1) to be used and the second data information or parameters, the social site 60 transmits this information to users who have stored on the social site 60 a certain social relationship with user1 such as, for example, user2, user5 and user7 shown in FIG. 5a.

In one implementation, social site 60 stores the IP address of the host H2, H5 and H7 used by user2 user5 and user7, respectively, and transmits the multicast channel information (S60, G1) and the second data information or parameters associated with the multicast transmission to hosts H2, H5 and H7 establishing the unicast communications shown in FIG. 7 by arrows 621, 631 and 641, respectively

In this way user2, user5 and user7 who store on the site 60 a specific social relationship with user1 can detect the start of a multicast transmission from the social site 60 of content transmitted by the host H1 and send routing messages to request to receive multicast channel traffic (S60, G1).

These routing messages can be, for example, IGMPv3 or MLDv2 messages sent by the hosts H2, H5 and H7 to the nearest router 310, 330 and 360, respectively, to receive multicast channel traffic (S60, G1). Multicast traffic request messages are shown in FIG. 7 by arrows 622, 632 and 642.

In some implementations, the hosts H2, H5 and H7 can send IGMPv3 or MLDv2 messages to request multicast channel traffic (S60, G1) transmitted by the social site 60. The router that receives these IGMPv3 or MLDv2 messages may turn them into PIM-SM messages which it sends towards the social site 60 until reaching a multicast router in the multicast tree that receives the multicast channel traffic (S60, G1).

The routers 310, 330 and 360 which receive messages from the host H2, H5 and H7, can use a multicast routing protocol between routers and send a JOIN (S60,G1) type PIM-SM message to the social site 60 to receive multicast traffic. Arrows 622, 632 and 642 include a “JOIN (S60, G1)” message that represent these PIM-SM messages going towards the social site 60 to receive multicast channel traffic (S60, G1).

When routers establish the multicast tree, such as a SPT-type multicast tree originating from the social site 60, the multicast traffic reaches the hosts H2, H5 and H7.

This multicast transmission of the content through multicast traffic of the multicast channel (S60, G1) transmitted from the social site 60 to the hosts H2, H5 and H7 is shown in FIG. 7 by the bold lines 623, 633 and 643, respectively.

In other implementations, host H1 may transmit the content to the social site 60 via encapsulated packets using any data packets encapsulation protocol such as “IP within IP”, GRE or any other data encapsulation protocol.

In some implementations, host H1 transmits the content via multicast channel (S60,G1) packets encapsulated as unicast IP packets, where the multicast packets have the G1 multicast group address as destination address and a source IP address S60 that is topologically correct in network 356. The unicast IP packets encapsulating the multicast packets have a destination address S60 associated with the social site 60 and source address S1. In some implementations, the host H1 receives from the social site 60 information comprising the IP address S60 that the host should use as a source address of the multicast packets.

The social site may remove the encapsulation of the multicast packets and transmit the multicast packets for example, to the router 350. By using the IP address S60 that is topologically correct in network 356, the problem of ingress filtering is avoided in the router 350.

In some implementations the communication between the host H1 and social site 60 may use mobility protocols such as Mobile IPv4, Mobile IPv6, Proxy Mobile IPv6 or any other mobility protocol where the host H1 may be the Mobile Node.

In some implementations the social site comprises a Mobile IP Home Agent and the host H1 use as source IP address of the multicast packets an IP address obtained from the Home Agent and then the host encapsulates the multicast packets using any encapsulation protocol used in the Mobile IP protocols and transmits the encapsulated packets to the Home Agent.

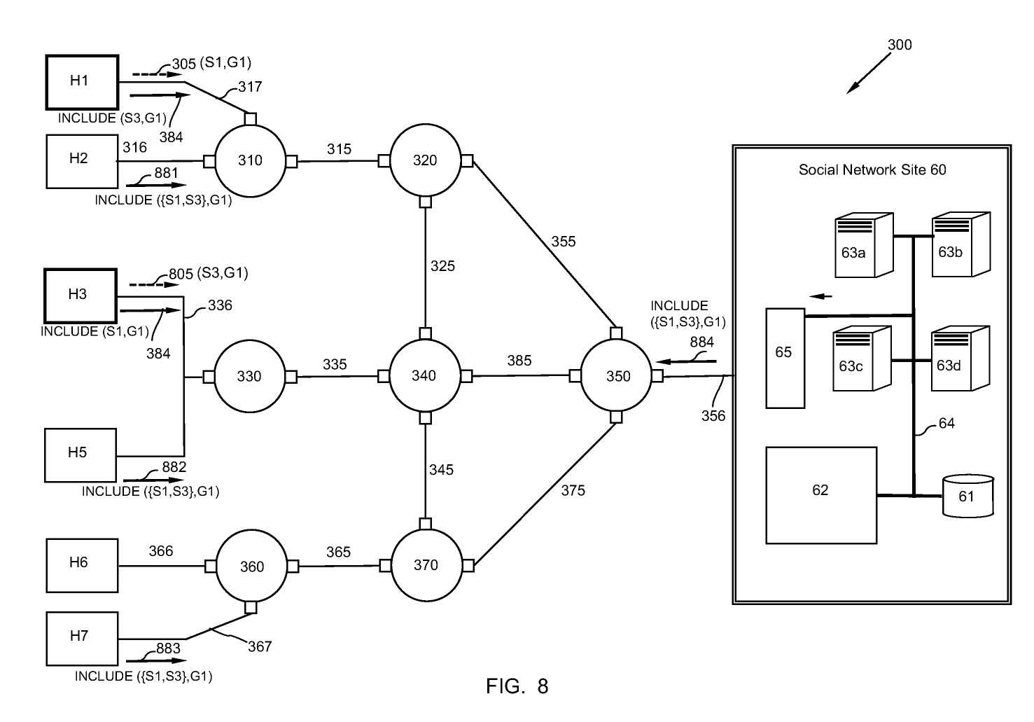

FIG. 8 shows another example of an implementation in which two hosts H1 and H3 transmit content via multicast data packets so that users who store on the site 60 a specific social relationship with user1 using the host H1 and/or user3 using the host H3 can receive the content transmitted by the host H1 and/or host H3 as multicast packets.

In FIG. 8, the host H1 transmits content using the multicast channel (S1, G1), where S1 is the IP address of the host H1 and host H3 transmits content using the multicast channel (S3, G1), where S3 is the IP address of the host H3. Other configurations are possible. For example the host H3 could use a multicast group address other than that used by the host 1, for example multicast group G2 different from G1.

The operation of the example in FIG. 8 is similar to the operation described in FIG. 3. The social site 60 transmits the information of the multicast channels (S1,G1) and (S3,G1) to the hosts of the users that have stored a social relationship with user 1 and user 3, respectively.

The hosts and the social site 60 that want to receive multicast traffic from the two multicast channels (S1, G1) and (S3, G1) send a message, for example using the IGMPv3 and/or MLDv2 protocols requesting multicast traffic from the multicast channels (S1, G1) and (S3, G1). These messages are indicated by arrows 881, 882, 883 and 884 indicated with the text INCLUDE ({S1, S3}, G1) indicating that they wish to receive multicast traffic from multicast channels (S1, G1) and (S3, G1).

The content sent by the hosts H1 and H3 in the different implementations can be any type of content such as text, voice, audio, images, video and any combination thereof and any other content.

In some implementations the hosts receiving a first content via multicast packets can send a second content related to the first content, such as messages to be read by users who are receiving the first content via multicast packets. In some implementations the hosts receiving first content via multicast packets can send this second content by unicast packets transmitted to the host transmitting the first content so that the second content may be included in the multicast transmission.

For example, in FIG. 8, user7 of host H7 can send a text message to the host H1, for example through direct communication with the host H1 or indirectly through social site 60, or another site.

When the host H1 receives the message from host H7 it can include it in the multicast channel data (S1, G1) so that all users receiving the multicast channel content (S1, G1) can read the message sent by the host H7.

In some implementations, host H1 may block the message sent by the host H7 and not include it in the multicast channel traffic (S1, G1), for example because the message sent from the host H7 is an inappropriate message or spam.

TABLE 1
Operation example of an IGMPv3 router.

| | STATE 1 | MESSAGE | STATE 2 | ACTIONS |
|---|---|---|---|---|
| 1. | INCLUDE (A) | IS_IN (B) | INCLUDE (A + B) | T(B) = GMI |
| 2. | INCLUDE (A) | IS_EX (B) | EXCLUDE (A * B, B − A) | T(B − A) = 0 |
| | | | | DEL (A − B) |
| | | | | GT = GMI |
| 3. | EXCLUDE (X, Y) | IS_IN (A) | EXCLUDE (X + A, Y − A) | T(A) = GMI |
| 4. | EXCLUDE (X, Y) | IS_EX (A) | EXCLUDE (A − Y, Y * A) | T(A − X − Y) = GMI |
| | | | | DEL (X − A) |
| | | | | DEL (Y − A) |
| | | | | GT = GMI |
| 5. | INCLUDE (A) | ALLOW (B) | INCLUDE (A + B) | T(B) = GMI |
| 6. | INCLUDE (A) | BLOCK (B) | INCLUDE (A) | SEND Q(G, A * B) |
| 7. | INCLUDE (A) | TO_EX (B) | EXCLUDE (A * B, B − A) | T(B − A) = 0 |
| | | | | DEL (A − B) |
| | | | | SEND Q(G, A * B) |
| | | | | GT = GMI |
| 8. | INCLUDE (A) | TO_IN (B) | INCLUDE (A + B) | T(B) = GMI |
| | | | | SEND Q(G, A − B) |
| 9. | EXCLUDE (X, Y) | ALLOW (A) | EXCLUDE (X + A, Y − A) | T(A) = GMI |
| 10. | EXCLUDE (X, Y) | BLOCK (A) | EXCLUDE (X + (A − Y), Y) | T(A − X − Y) = GT |
| | | | | SEND Q(G, A − Y) |
| 11. | EXCLUDE (X, Y) | TO_EX (A) | EXCLUDE (A − Y, Y * A) | T(A − X − Y) = GT |
| | | | | DEL (X − A) |
| | | | | DEL (Y − A) |
| | | | | SEND Q(G, A − Y) |
| | | | | GT = GMI |
| 12. | EXCLUDE (X, Y) | TO_IN (A) | EXCLUDE (X + A, Y − A) | T(A) = GMI |
| | | | | SEND Q(G, X − A) |
| | | | | SEND Q(G) |

What is claimed is:

1. A method of transmitting first content from a first host to a second host in a data network using a social network site in the data network, the first host identifiable by a first IP address, the method comprising:
receiving in the social network site a first unicast message from the first host related to a transmission of the first content from the first host, the first unicast message comprising the first IP address and a multicast group address to be used in the transmission of the first content;
the social network site determining that a social relationship exists between the first host and the second host; and
after determining that a social relationship exists between the first host and the second host the social network site sending a second unicast message to the second host indicating that the first host has or will initiate a transmission of the first content, the second unicast message comprising the first IP address and the multicast group address in a form useable by the second host to request and receive via the data network the first content in the form of multicast packets.

2. A method of transmitting first content from a first host to a second host in a data network using a social network site in the data network, the first host identifiable by a first IP address, the method comprising:
receiving in the social network site a first unicast message from the first host related to a transmission of the first content from the first host, the first unicast message comprising the first IP address;
the social network site determining that a social relationship exists between the first host and the second host;
the social network site selecting a multicast group address for the transmission of the first content and sending to the first host information about the multicast group address; and
after determining that a social relationship exists between the first host and the second host the social network site sending a second unicast message to the second host indicating that the first host has or will initiate a transmission of the first content, the second unicast message comprising the first IP address and the selected multicast group address.

3. A method of transmitting first content from a first host to a second host in a data network using a social network site in the data network, the first host identifiable by a first IP address, the method comprising:
receiving in the social network site a first unicast message from the first host related to a transmission of the first content from the first host, the first unicast message comprising the first IP address;
the social network site determining that a social relationship exists between the first host and the second host;
after determining that a social relationship exists between the first host and the second host the social network site selecting a multicast group address for the transmission of the first content and sending to the first host information about the multicast group address; and
after determining that a social relationship exists between the first host and the second host and selecting the multicast group address the social network site sending a second unicast message to the second host indicating that the first host has or will initiate a transmission of the first content, the second unicast message comprising the first IP address and the selected multicast group address.

4. A method of transmitting first content from a first host to a second host in a data network using a social network site in the data network, the first host identifiable by a first IP address, the method comprising:
receiving in the social network site a first unicast message from the first host related to a transmission of the first content from the first host, the first unicast message comprising the first IP address;
the social network site determining that a social relationship exists between the first host and the second host;
the social network site selecting a multicast group address for the transmission of the first content and sending to the first host information about the multicast group address;
after determining that a social relationship exists between the first host and the second host the social network site sending a second unicast message to the second host indicating that the first host has or will initiate a transmission of the first content, the second unicast message comprising a selected source IP address and the selected multicast group address;
receiving in the social network site the first content in the form of unicast packets; and
transmitting from the social network site to a router in the data network that is accessible by the second host the first content in the form of multicast packets using the selected source IP address and the selected multicast group address.

5. A method of transmitting first content from a first host to a second host in a data network using a social network site in the data network, the first host identifiable by a first IP address, the method comprising:
receiving in the social network site a first unicast message from the first host related to a transmission of the first content from the first host, the first unicast message comprising the first IP address;
the social network site determining that a social relationship exists between the first host and the second host;
after determining that a social relationship exists between the first host and the second host the social network site selecting a multicast group address for the transmission of the first content and sending to the first host information about the multicast group address;
upon or after the social network site sending to the first host information about the multicast group to be used in the transmission of the first content, the social network site sending a second unicast message to the second host indicating that the first host has or will initiate a transmission of the first content, the second unicast message comprising a selected source IP address and the selected multicast group;
receiving in the social network site the first content in the form of unicast packets;
transmitting from the social network site to a router in the data network that is accessible by the second host the first content in the form of multicast packets using the selected source IP address and the selected multicast group address.

6. A method of transmitting first content from a first host to a second host in a data network using a social network site in the data network, the first host identifiable by a first IP address, the method comprising:
receiving in the social network site a first unicast message from the first host related to a transmission of the first content from the first host, the first unicast message comprising the first IP address and a multicast group address to be used in the transmission of the first content;
the social network site determining that a social relationship exists between the first host and the second host;
after determining that a social relationship exists between the first host and the second host the social network site sending a second unicast message to the second host indicating that the first host has or will initiate a transmission of the first content, the second unicast message comprising a selected source IP address and the multicast group address;
receiving in the social network site the first content in the form of unicast packets;
transmitting from the social network site to a router in the data network that is accessible by the second host the first content in the form of multicast packets using the selected source IP address and the selected multicast group address.

7. A method of transmitting multicast packets from a first host to a second host in a data network using a social network site in the data network, the first host identifiable by a first IP address, the method comprising:
receiving in the social network site a first unicast message from the first host related to a transmission of the first content from the first host, the first unicast message comprising a second IP address and a multicast group address to be used in the transmission of the first content;
the social network site determining that a social relationship exists between the first host and the second host;
after determining that a social relationship exists between the first host and the second host receiving in the social network site from the first host encapsulated unicast packets comprising the multicast packets;
after determining that a social relationship exists between the first host and the second host the social network site sending a second unicast message to the second host indicating that the first host has or will initiate a transmission of the first content, the second unicast message comprising the second IP address and the multicast group; and
the social network site removing the encapsulation of the unicast packets comprising the multicast packets and transmitting the multicast packets from the social network site to a router in the data network using the second IP address as source address of the multicast IP packets and the selected multicast group as destination IP address of the multicast IP packets.

8. A method according to claim 7, wherein the first host receives from the social network site the second IP address.
